(19) United States
(12) Patent Application Publication
(10) Pub. No.: US 2015/0153789 A1
(43) Pub. Date: Jun. 4, 2015

(54) MOUNTING DEVICE FOR HARD DISK DRIVE

(71) Applicants: HON HAI PRECISION INDUSTRY CO., LTD., Shenzhen (CN); HONG FU JIN PRECISION INDUSTRY (ShenZhen) CO., LTD., Shenzhen (CN)

(72) Inventor: AN-GANG LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/141,444

(22) Filed: Dec. 27, 2013

(30) Foreign Application Priority Data
Nov. 29, 2013 (CN) 2013106202835

(51) Int. Cl. G06F 1/18

(52) U.S. Cl. CPC G06F 1/184

(57) ABSTRACT

A mounting device comprises two sidewalls, a connecting portion defining a receiving slot, a fixing member, and a latching member slidably received in the receiving slot. A blocking piece and a connecting wall are connected between a top wall and a bottom wall of the receiving slot. A first end of the fixing member forming two projections is pivotably connected to the first end of the connecting portion. The projections are received in the receiving slot. A tab extends from a second end of the fixing member. The latching member comprises a plate blocked by the blocking piece, and an extension piece blocked by the connecting wall. The fixing member is pivoted toward the latching member to allow the projections to extend out of the receiving slot. The latching member is slid toward the fixing member to block the tab.

### BACKGROUND

1. Technical Field

The present disclosure relates to a device for mounting a hard disk drive.

2. Description of Related Art

Data storage device, such as hard disk drives, are usually mounted in a computer enclosure by screws. However, it is difficult and time-consuming to mount the hard disk drives with screws. In addition, vibration of the data storage devices in use may cause the screws to become loose, which may damage the data storage devices.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting device, together with a hard disk drive and a conversion card.

FIG. 2 is similar to FIG. 1, but viewed from another perspective.

FIG. 3 is an assembled, isometric view of the mounting device of FIG. 2.

FIG. 4 is an assembled, isometric view of FIG. 1.

FIG. 5 is a cross-sectional view of FIG. 4, taken along line V-V.

### DETAILED DESCRIPTION

The disclosure, comprising the accompanying drawings, is illustrated by way of example and not by way of limitation. It should be noted that references to “an” or “one” embodiment in this disclosure are not necessarily to the same embodiment, and such references mean “at least one.”

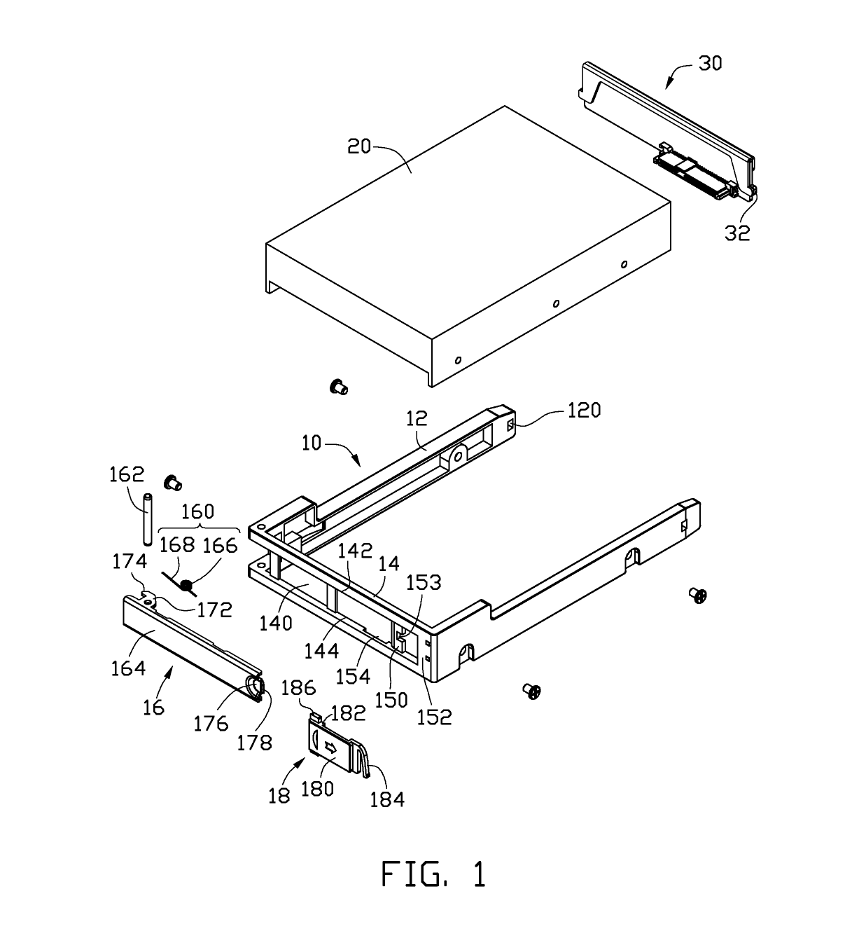

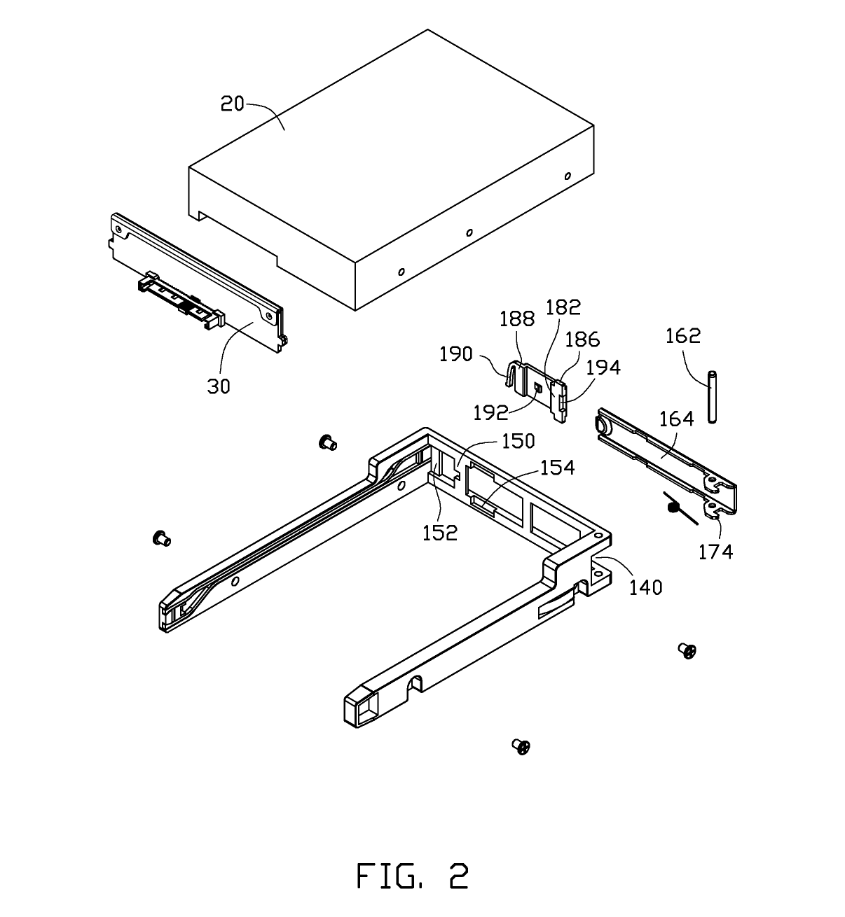

FIGS. 1 and 2 show an embodiment of a mounting device 10 for mounting a hard disk drive (HDD) 20 and a conversion card 30.

The mounting device 10 comprises two sidewalls 12, a connecting portion 14 connected between first end portions of the sidewalls 12, a fixing member 16 pivotably mounted to a first end portion of the connecting portion 14, and a latching member 18 slidably mounted to a second end portion of the connecting portion 14.

A second end portion of each sidewall 12 defines a through hole 120.

The connecting portion 14 comprises a top wall 142, a bottom wall 144, and a connecting wall 152 between second end portions of the top wall 142 and the bottom wall 144. The connecting portion 14 defines a receiving slot 140 extending through the first end portion of the connecting portion 14. A blocking piece 150 is connected between the top wall 142 and the bottom wall 144, and adjacent to the connecting wall 152. A cutout 153 is defined in a side of the blocking piece 150 facing the connecting wall 152. An inner side of each of the top wall 142 and the bottom wall 144 defines a sliding groove 154. The sliding grooves 154 are adjacent to a side of the blocking piece 150 opposite from the side defining the cutout 153.

The fixing member 16 comprises a bar 164, a pin 162, and a torsion spring 160. The torsion spring 160 comprises a main body 166 and two legs 168 extending from opposite ends of the main body 166, respectively. Two arms 172 extend from an inner side of a first end portion of the bar 164. A recess 176 is defined in an outer side of a second end portion of the bar 164, and a tab 178 is formed at the second end portion of the bar 164. The tab 178 extends slantingly from a bottom edge of the recess 176 in a direction away from the first end of the bar 164. Two projections 174 extend from distal ends of the arms 172 and away from the tab 178.

The latching member 18 comprises a plate 180, a first latching portion 182 formed at a first end portion of an inner side of the plate 180, and a second latching portion 184 formed at a second end portion of the inner side of the plate 180. The first latching portion 182 comprises two protrusions 186 extending from a top side and a bottom side of the plate 180, respectively. The second latching portion 184 comprises an extension piece 188 extending from the second end portion of the plate 180, and a resilient piece 190 extending slantingly from a top portion of the extension piece 188 toward a bottom portion of the extension piece 188. A block 192 protrudes from the inner side of the plate 180. An engaging hole 194 is defined in an inner surface of the first latching portion 182 and between the protrusions 186.

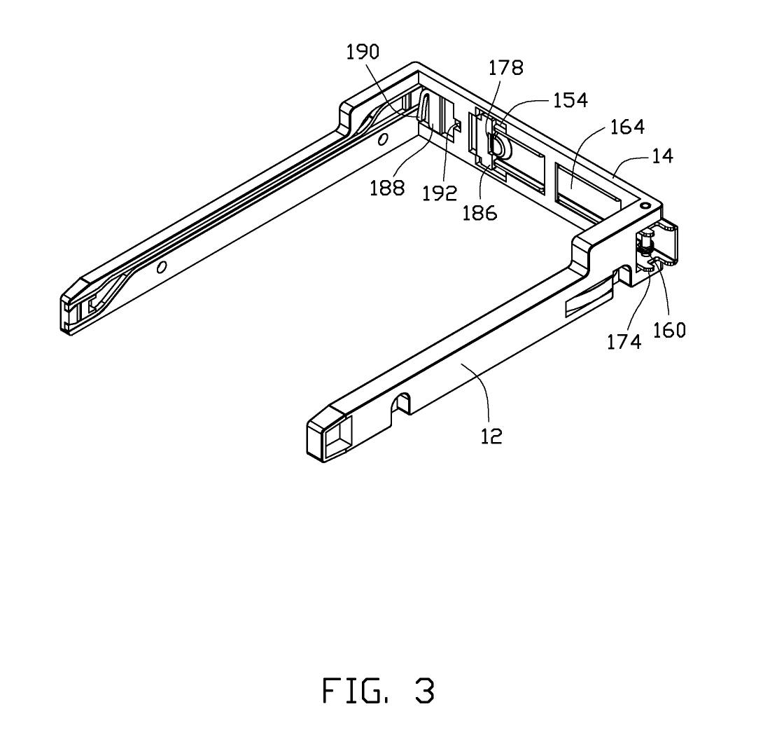

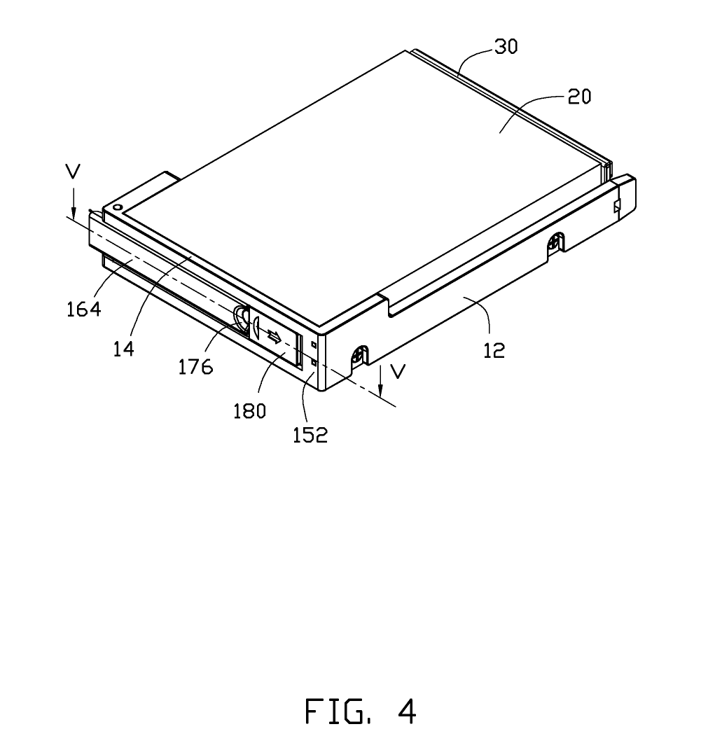

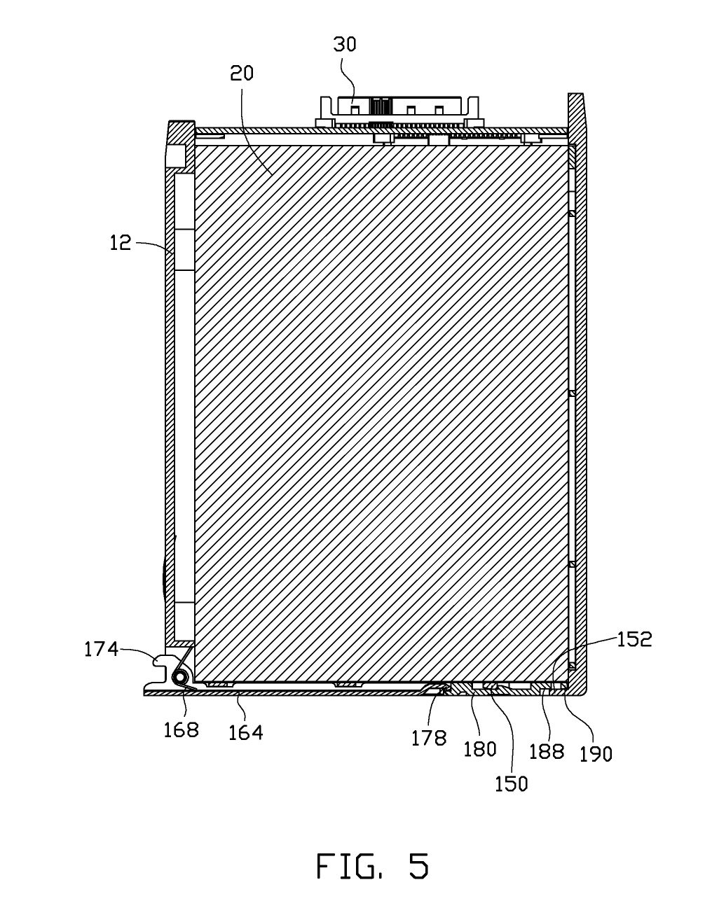

Referring to FIGS. 3 to 5, in assembly, the pin 162 is received through the top wall 142, one of the arms 172, the main body 166 of the torsion spring 160, and the other arm 172, and then one end portion of the pin 162 is received in the bottom wall 144, thereby pivotably mounting the fixing member 16 to the first end portion of the connecting portion 14. The legs 168 resist against the inner side of the bar 164 and the adjacent sidewall 12. In an original state, the bar 16 is slanted relative to the connecting portion 14, and the projections 174 are received in the receiving slot 140.

The latching member 18 is received in the second end portion of the receiving slot 140 and abuts an outer side of the blocking piece 150. The protrusions 186 are slidably received in the sliding grooves 154. The extension piece 188 and the resilient piece 190 abut an inner surface of the connecting wall 152. The resilient piece 190 further abuts an inner surface of the corresponding sidewall 12. In an original state of the latching member 18, the block 192 is received in the cutout 153.

The HDD 20 is mounted between the sidewalls 12 and to the connecting portion 14. The conversion card 30 comprises two inserting portions 32 to be received in the two through holes 120, respectively, and the conversion card 30 is electrically connected to the HDD 20.

After the mounting device 10 is received in a receiving space of a chassis (not shown), the fixing member 16 is pivoted toward the connecting portion 14. The tab 178 pushes the latching member 18 toward the connecting wall 152 to deform the resilient piece 190, and the block 192 extends out of the cutout 153. After the tab 178 passes over the plate 180, the resilient piece 190 is restored, and the plate 180 moves back to block the tab 178. The block 192 is received in the cutout 153 and blocked by the blocking piece 150. The tab 178 is engagingly received in the engaging hole 194. The legs 168 are deformed. At this time, the projections 174 are exposed out of the receiving slot 140 to be engaged in the chassis, and the mounting device 10 is fixed to the chassis.

In uninstalling the mounting device 10, the latching member 18 is moved toward the connecting wall 152 to remove the tab 178 from the engaging hole 194. The legs 168 are restored to push the second end portion of the bar 164 away from the connecting portion 14 and disengage the projections 174 from the chassis. Therefore, the mounting device 10 together with the HDD 20 is easily taken out of the chassis.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a hard disk drive and a conversion card connected to the hard disk drive, the mounting device comprising:
two sidewalls;
a connecting portion connected between first end portions of the sidewalls and defining a receiving slot extending through a first end portion of the connecting portion;
the connecting portion comprising a top wall and a bottom wall; wherein a connecting wall is connected between the top wall and the bottom wall at a second end portion of the connecting portion opposite to the first end portion, and a blocking piece is connected between the inner sides of the top wall and the bottom wall, and between the connecting wall and the first end portion of the connecting portion;
a fixing member comprising a first end pivotably mounted to the first end portion of the connecting portion and a second end opposite to the first end; two projections extending from the first end of the fixing member and received in the receiving slot, a tab extending out from the second end of the fixing member; and
a latching member comprising a plate slidably received in the receiving slot and blocked by an outer side of the blocking piece, and an extension piece extending out from an end of the plate away from the fixing member and blocked by an inner side of the connecting wall;
wherein, when the fixing member is pivoted toward the latching member, the projection is caused to extend out of the receiving slot, the latching member is slid toward the fixing member to allow the plate to block the tab.

2. The mounting device of claim 1, wherein the top wall and the bottom wall each define a sliding groove in an inner side, two protrusions protrude from a top side and a bottom side of the plate to be slidably received in the sliding grooves.

3. The mounting device of claim 1, wherein the fixing member further comprises a resilient piece extending out from the extension piece to abut the connecting wall and the adjacent sidewall.

4. The mounting device of claim 3, wherein the resilient piece slantingly extends out from a top side of the extension piece toward a bottom side of the extension piece.

5. The mounting device of claim 1, wherein the fixing member comprises a bar and a torsion spring mounted between the bar and the connecting portion, legs of the torsion spring abut the bar and the adjacent sidewall.

6. The mounting device of claim 5, wherein the fixing member further comprises a pin, the bar comprises two arms extending from an inner surface of the first end of the bar, the projections extend out from the arms in a direction away from the latching member, the torsion spring is located between the arms, the pin extends through the top wall, one of the arms, the torsion spring, the other arm, and then is engaged in the bottom wall.

7. The mounting device of claim 1, wherein the sidewalls define two through holes in second end portions of the sidewalls opposite to the connecting portion, to mount the conversion card.

8. The mounting device of claim 1, wherein the plate forms a block protruding from an inner side of the plate, the block abuts the blocking piece when the tab is blocked by the plate.

9. The mounting device of claim 8, wherein the blocking piece defines a cutout facing the connecting wall to receive the block.
